(19) United States
(12) Patent Application Publication
(10) Pub. No.: US 2016/0364813 A1
(43) Pub. Date: Dec. 15, 2016

(54) SYSTEM FOR CREATING A LINKAGE FAMILY TREE INCLUDING NON-REQUESTED ENTITIES AND DETECTING CHANGES TO THE TREE VIA AN INTELLIGENT CHANGE DETECTION SYSTEM

(71) Applicant: D&B BUSINESS INFORMATION SOLUTIONS, DUBLIN (IE)

(72) Inventors: Conor O'REILLY, Dublin (IE); Richard JONES, Greystones (IE); Dermot REYNOLDS, Drogheda (IE); Kevin MAGEE, Blackrock (IE)

(21) Appl. No.: 15/179,523

(22) Filed: Jun. 10, 2016

Related U.S. Application Data
(60) Provisional application No. 62/174,733, filed on Jun. 12, 2015.

(51) Int. Cl. G06Q 50/00; H04L 29/08

(52) U.S. Cl. CPC G06Q 50/01; H04L 67/22; H04L 67/306

(57) ABSTRACT

A method and system provides a predictive monitoring platform that identifies related but previously unspecified corporate entities that are in fact actually of interest to a customer. The method and system use a computer with a program module for a series of steps that search for and provide a list of previously unlinked corporate entities that are of potential interest to the customer for monitoring.

### CROSS-REFERENCED APPLICATIONS

This application claims priority to U.S. Provisional Application No. 62/174,733, filed on Jun. 12, 2015, which is incorporated herein in its entirety.

### BACKGROUND

1. Field of the Disclosure

This disclosure relates to a method and system that provide predictive detection of changes for entities that are being monitored, especially a system which uses intelligent change detection to identify changed items that were not specifically requested but are, in fact, actually of interest to a user.

2. Discussion of the Background Art

In standard monitoring or notification scenarios there is a requirement on the requester (or process acting for the requester) to specify information of interest to be obtained. Alerting systems typically provide an alert based on generic system activity rather than directly requested information. These systems typically provide only information that is specifically requested. The technical problem is that most alerting/monitoring systems can only monitor companies selected by a requester/user and are incapable of monitoring other companies or entities of interested based upon association with the identified companies or entities by the requester/user.

There is a need for a method and a system that identifies items, which are actually of interest, though not specifically requested by a user.

### SUMMARY

The method and system of the present disclosure provides a predictive monitoring platform that identifies related but previously unspecified corporate entities that are in fact actually of interest to a user. This creates a powerful capability for users by providing unknown changes that might be of relevance to them.

In particular, the method and system identify additional corporate entities (and/or contacts associated with the additional corporate entities or other entities) that the user should be monitoring and allows the user to refine the range or parameters of interest associated with the additional corporate entities that are identified by the predictive monitoring platform using the intelligent change detection system of the present disclosure.

An embodiment of the method of the present disclosure monitors corporate entities for a requester (i.e. user) with a program module of a computer, which executes the following steps:

obtaining a request for previously unlinked, corporate entities of potential interest for monitoring for the requester;

based on the request, obtaining one or more previously unlinked, corporate entities from a seed list of previously unlinked corporate entities;

establishing a linkage tree that includes the request and the obtained one or more related, but previously unlinked, corporate entities;

based on a linkage change log, finding linkage changes of the linkage tree that comprise one or more of the previously unlinked corporate entities for monitoring, which are of interest to the requester for monitoring; and

assembling a related list that includes the request and the one or more of the potential related, but previously unlinked, corporate entities of the found linkage changes.

The method of the disclosure further comprises an embodiment in which the request includes an identity of a currently monitored corporate entity.

The method of the disclosure further comprises an embodiment in which the linkage tree comprises one or more nodes for the request and the previously unlinked corporate entities.

The method of the disclosure further comprises an embodiment in which the establishing step (a) adds a node to an existing linkage tree as a child node of a parent node of the nodes, or (b) deletes one of the nodes by removal, or (c) moves one of the nodes from one parent node to another parent node of the plurality of nodes.

The method of the disclosure further comprises an embodiment in which exemplary outputs of the establishing step comprise time stamp, an entity identity, action and a parent identity.

An embodiment of the system of the present disclosure monitors corporate entities for a requester with a computer that has access to a memory with a program module for controlling predictive monitoring of related entities. The computer controls the program module to execute the following steps:

obtaining a request for previously unlinked, corporate entities of potential interest for monitoring for the requester;

based on the request, obtaining one or more previously unlinked, corporate entities from a seed list of previously unlinked corporate entities;

establishing a linkage tree that includes the request and the obtained one or more related, but previously unlinked, corporate entities;

based on a linkage change log, finding linkage changes of the linkage tree that comprise one or more of the previously unlinked corporate entities for monitoring, which are of interest to the requester for monitoring; and

assembling a related list that includes the request and the one or more of the potential related, but previously unlinked, corporate entities of the found linkage changes.

A computer readable storage media containing executable computer program instructions which when executed cause a processing system to perform a method for monitoring corporate entities for a requester comprising:

obtaining a request for previously unlinked, corporate entities of potential interest for monitoring for the requester;

based on the request, obtaining one or more previously unlinked, corporate entities from a seed list of previously unlinked corporate entities;

constructing a linkage tree that includes the request and the obtained one or more related, but previously unlinked, corporate entities;

based on a linkage change log, identifying linkage changes of the linkage tree that comprise one or more of the previously unlinked corporate entities for monitoring, which are of interest to the requester for monitoring; and

assembling a related list that includes the request and the one or more of the potential related, but previously unlinked, corporate entities of the found linkage changes.

### BRIEF DESCRIPTION OF THE DRAWINGS

Other and further objects, advantages and features of the present disclosure will be understood by reference to the following specification in conjunction with the accompanying drawings, in which like reference characters denote like elements of structure and:

FIG. 1 is a block diagram of a system for carrying out the method of the present disclosure;

FIG. 2 is a block diagram of the method that assembles a list of related entities from a seed list;

FIG. 3 is a diagram of operations performed by the method of FIG. 2: and

FIG. 4 is a linkage tree diagram for the operations of FIG. 3.

### DETAILED DESCRIPTION OF THE PREFERRED EMBODIMENT

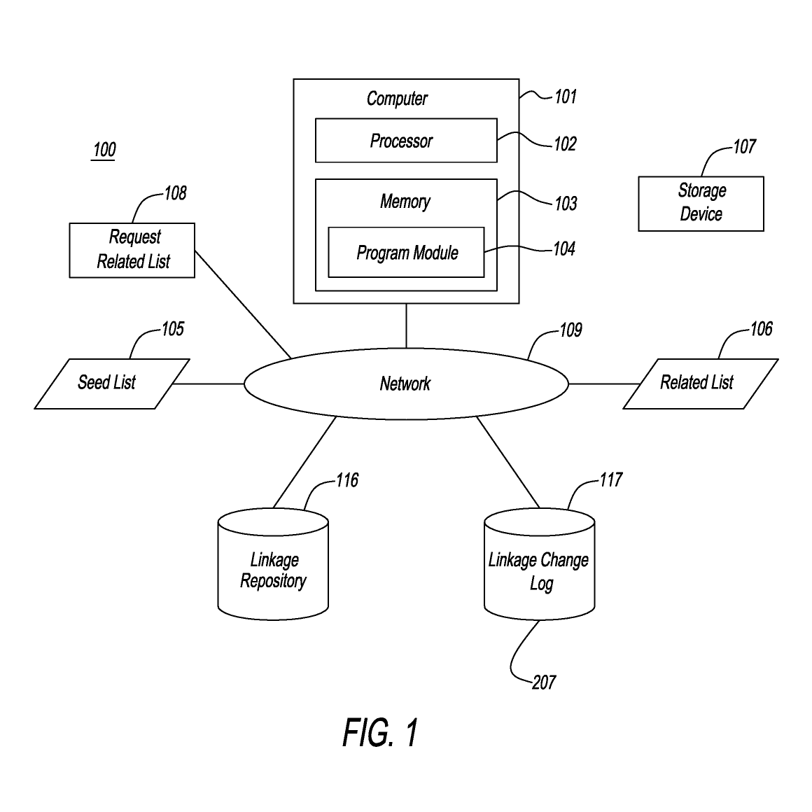

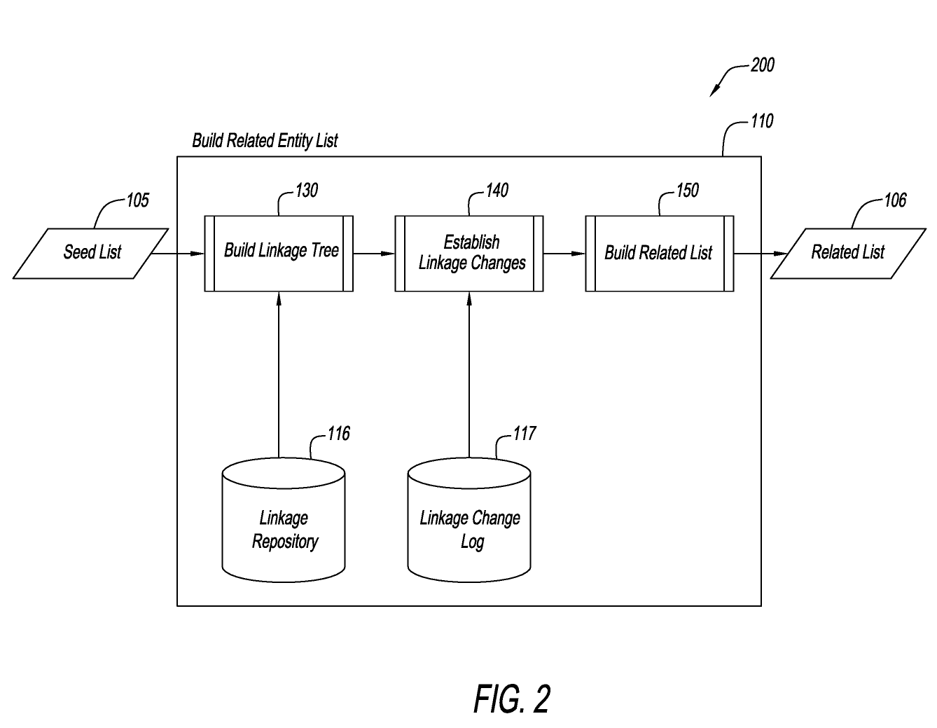

Referring to FIGS. 1 and 2, an exemplary system 100 is shown for providing execution of a method 200 of the present disclosure. Referring firstly to FIG. 1, system 100 comprises a computer 101, a request related list 108, a seed list 105, a linkage repository 116, a linkage change log 117 and a related list 106 that are each interconnected with a network 109. Network 109 may be a private network or a broader network, for example, the internet. In some embodiments there may be one or more computers, request related lists, seed lists, linkage repositories, linkage change logs and related lists.

Computer 101 comprises a processor 102 and a memory 103. A program module 104 is disposed in memory 103. Processor 102 is operable to execute instructions of program module 104 for performing method 200, using network 109, request related list 108, seed list 105, linkage repository 116, linkage change log 117 and related list 106.

While program module 104 is shown as already loaded into memory 103, program module 104 may be configured on a storage device 107 for subsequent loading into memory 103. Storage device 107 is a tangible, non-transitory, computer-readable storage device that is capable of storing program module 104 thereon. Examples of storage device 107 include a compact disk, a magnetic tape, a read only memory, an optical storage medium, a hard drive or a memory unit consisting of multiple hard drives, and a universal serial bus (USB) flash drive. Alternatively, storage device 107 can be a random access memory, or other type of electronic storage device, located on a remote storage system and coupled to computer 101 via network 109.

Request related list 108 comprises a list of related known corporate entities that are being monitored for a requester/user. Seed list 105 comprises a list of potential related, but previously unspecified, corporate entities. Method 200 processes a request of the requester/user for a corporate entity from related list 108 (i.e. specific entities to monitor) and one or more potential related, but previously unspecified, corporate entities from see list 105 (i.e. actual list of monitored entities which contains all the related know corporate entities) to produce a related list 106 for the requester/user.

For example, the requester/user is monitoring a list of known corporate entities from request related list 108 for changes related to the known corporate entities. One of the known corporate entities being monitored undertakes a merger, acquisition or other corporate action that results in one or more new corporate entities becoming related to the list of known corporate entities being monitored. Method 200 identifies the related new corporate entities based on the changes to the underlying data of the customer's list of the known corporate entities. The requester/user is then given the data for the newly identified, previously unlinked, corporate entities along with the data for the known corporate entities being monitored.

Referring to FIGS. 1 and 2, method 200 comprises a build related corporate entity list 110 that comprises a series of process steps that are executed by program module 104 of computer 101 and that include a build linkage tree step 130, an establish linkage changes step 140 and a build related list step 150. Build linkage tree step 130 builds or modifies an existing linkage tree based on a requester/user's request from request related list 108, seed list 105 and a linkage repository 116. Establish linkage changes step 140 determines the presence or absence of linkage changes to the requester/user's existing corporate data, based on the linkage tree and a linkage change log 117. That is, establish linkage changes 140 identifies any new corporate entities from seed list 105, which were previously unlinked, to requester/user's know company listing from request related list 108, thereby allowing the system to build related list 150. Related list 106 is based on the linkage changes provided by establish linkage changes step 140, wherein related list 106 comprises new and previously unlinked corporate entities.

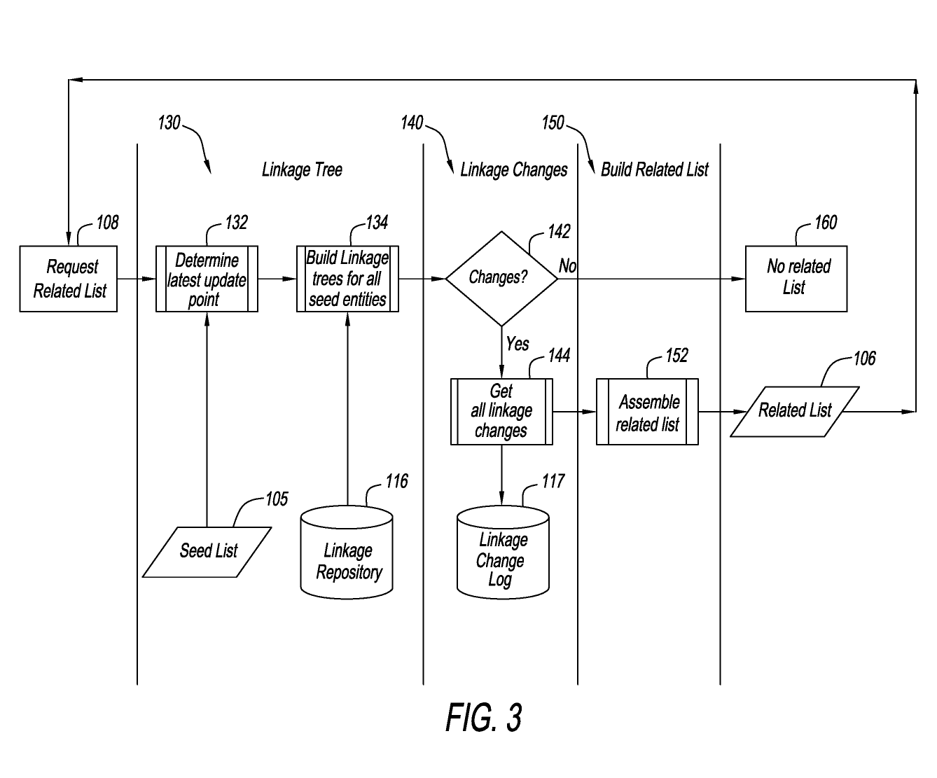

Referring to FIG. 3, build linkage tree 130 is executed based on request related list 108 to build a linkage tree or to modify an existing linkage tree from request related list 108 by incorporating each additional, previously unlinked, corporate entity from seed list 105. Build linkage tree 30 comprises a read seed list (i.e. determine latest update point) 132 and a build linkage trees for all seed entities 134. Read seed list 132 reads seed list 105 for a list of seed corporate entities that correspond to a requester/user's request provided by request related list 108. The list of seed corporate entities 105 and request related list 108 are presented to build or modify linkage trees 134 to include all seed list corporate entities. Build linkage trees step 134 builds a linkage tree for each seed list corporate entity provided to step 132 based on data in linkage repository 116. A linkage tree created in step 134, for example, uses a directed graph structure. Preferably, a directed graph (or digraph) is a graph, or set of nodes connected by edges, where each edge has an associated direction.

A “related list” request 108 contains a simple list of known entities being monitored. For each unknown entity in the seed list 105 there are related items in subsequent steps. Each entity in the seed list 105 is part of a linkage tree family is generated from the related list request 108. It may not be at the apex of the tree as it may reference a subsidiary company and, therefore, has a parent(s). It may also have child entities.

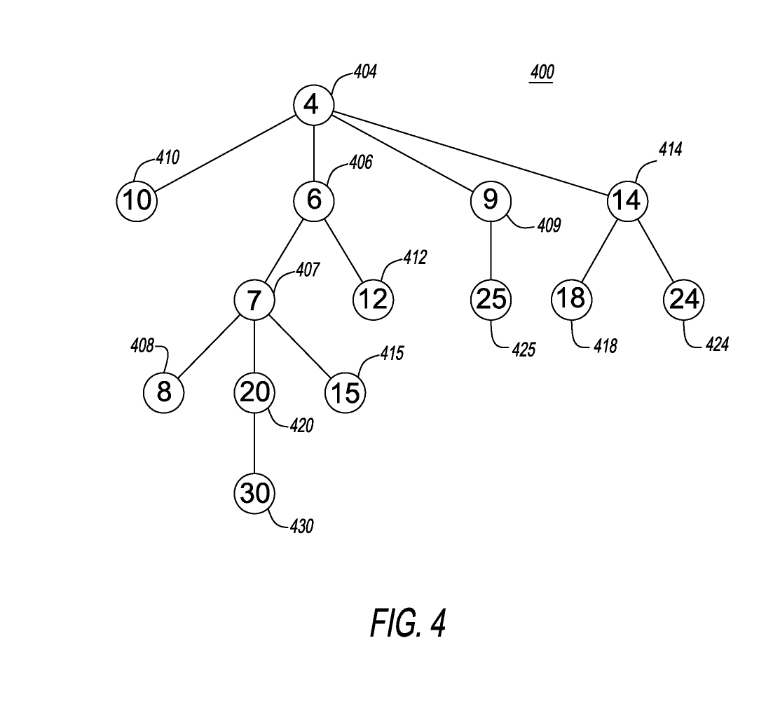

Referring to FIG. 4, one embodiment is shown for a tree family 400 that comprises a plurality of nodes 404, 406, 407, 408, 409, 410, 412, 414, 415, 418, 420, 424, 425 and 430. Each node represents a previously known entity from request related list 108. In this example, known entities of the request related list 108 are represented by nodes 404, 420 and 418. In this example, the top of the tree is node 404 and does not have any parent nodes. Nodes 418 and 420 are child nodes further down the tree and have parents. Node 418 has parents 414 and 404. Node 420 has parents 407, 406 and 404. The remaining nodes 408, 409, 410, 412, 415, 424 and 425 are potential corporate entities of interest that are presently unknown to the requestor/user and generated from seed list 105 via determine latest update point 132.

A separate tree family is built around each previously unlinked corporate entity found in seed list 105. In the example above, only one linkage tree is created. For entities in multiple linkage families, multiple linkage family trees are built.

Establish linkage changes 140 logs changes to the linkage family tree built in step 134 as additions, deletions and/or moves from the seed list 105 versus linkage repository 116. The entity identification number, entity relationships (i.e. how various entities are linked such as owned, shareholder, competitor, etc.) and meta data (i.e. date relationship identified) are stored in linkage repository 116. In all cases the changes are time stamped. In an addition change, the entity is added to the linkage tree as a child node. For example in FIG. 4, one or more of nodes 408, 409, 410, 412, 415, 424 and 425 are added as child nodes. In a deletion change, one or more of the nodes is removed. The deleted entity is recorded and the parent is also recorded. In a move change, the entity is moved from one parent to another. The moved entity, its new parent and its previous parent and their respective nodes are recorded.

Exemplary outputs of linkage tree step 140 for the addition, deletion and/or move changes comprise:
Addition: time stamp, entity identity, action: add, detail: parent identity;
Move: time stamp, entity identity, action: move, detail: old parent identity and new parent identity; and
Deletion: time stamp, entity identity, action: delete, detail: parent identity.

Establish linkage changes 140 reviews the linkage tree 134 to determine if any changes were made to the linkage tree 134 since the last update. If no changes are detected by the intelligent change detection system, then no related list 160 needs to be constructed. If changes to linkage tree 134 were detected by the intelligent change detection system, then step 144 retrieves all linkage changes from a changes step 142, stores the changes in linkage change log 117. Linkage changes log 117 contains a log of all changes, with time stamps, to all linkage family trees generated from linkage tree step 130. The time period can be a specific date and time range or can be set to cover all changes for a linkage family tree. If the linkage family tree has a change 142, then step 144 retrieves from linkage change log 117 all linkage changes to the linkage family tree structure for the linkage family tree that have been created within a required time period.

The intelligent change detection system is set forth in copending U.S. patent application Ser. No. 15/073,369, filed on Mar. 17, 2016, which is incorporated herein in its entirety by reference thereto. The intelligent change detection system compares the data element to a corresponding data element in a pend update history repository that contains changes that have occurred to the data element over time, thus yielding a comparison, and determining, based on the comparison, that the data element has changed.

In particular, the update detection stage includes a change detection process and an apply business rules process. The update detection stage runs as part of a regular operational cycle, typically daily, but can be more often.

The change detection process uses the field-element files for downstream mapping and comparison. The change detection process detects all changed elements across all field-element files. These changes are aggregated, and the change detection process compares the field-elements in the field-element files against a current value of those elements in the pend update history repository.

The apply business rules process applies business rules logic that decides which field-element values to actually update in the full universe data repository and delta data repository. The elementification process can process files from various data sources either sequentially or in parallel. As such, the processing of files from these sources by the elementification process can all begin at the same time. The apply business rules process manages temporal integrity and will only release updates in sequence, even if the elementification process processed the sources in parallel. Also, depending on the content and size of each file, some may be processed faster than others, and so, the apply business rules process performs a temporal integrity check to ensure updates are applied in the correct order.

Build related list 150 comprises an assemble related list step 152 that for each linkage family tree assembles a new related corporate entity or entities for storage in related list 106. Thereafter, the new related corporate entity or entities stored in related list 106 is looped back to Request Related List 108, i.e. information that is looped back to 108 will be linked to the corporate entity data plus how the relationship has been identified.

An example of how this system operates is as follows. Requester/User “Gorham Inc.” provides system 100 with a seed list 105 of entities for processing, seed list 105 contains the following entities:

| Customer | |
|---|---|
| Reference | Company Name |
| 1 | Stark Enterprises |
| 2 | Marvel Inc. |
| 3 | Acme Inc. |
| 4 | Gotham Bank |

Linkage repository 116 is used to build linkage tree 130. Tree 130 is monitored for changes using the process outlined in 140. Once a change is detected, related list 150 is built in the case of the Gorham Inc. customer list wherein the following entity is identified as a new related company.

| Customer | |
|---|---|
| Reference | Company Name |
| | Wayne Enterprises |

Related list 106 is returned to the customer for inclusion on their seed list 105.

| Customer | |
|---|---|
| Reference | Company Name |
| 1 | Stark Enterprises |
| 2 | Marvel Inc. |
| 3 | Acme Inc. |
| 4 | Gotham Bank |
| 5 | Wayne Enterprises |

Seed list 105 can be resubmitted to the process to identify potential changes to this new seed list in a continuous recursive manner.

The present disclosure having been thus described with particular reference to the preferred forms thereof, it will be obvious that various changes and modifications may be made therein without departing from the spirit and scope of the present disclosure as defined in the appended claims.

What is claimed is:

1. A method for monitoring corporate entities for a requester comprising:
with a program module of a computer, executing the following steps:
obtaining a request for previously unlinked, corporate entities of potential interest for monitoring for said requester;
based on said request, obtaining one or more previously unlinked, corporate entities from a seed list of previously unlinked corporate entities;
constructing a linkage tree that includes said request and said obtained one or more related, but previously unlinked, corporate entities;
based on a linkage change log, identifying linkage changes of said linkage tree that comprise one or more of said previously unlinked corporate entities for monitoring, which are of interest to said requester for monitoring; and
assembling a related list that includes said request and said one or more of said potential related, but previously unlinked, corporate entities of said found linkage changes.

2. The method of claim 1, wherein said request includes an identity of a currently monitored corporate entity.

3. The method of claim 2, wherein said linkage tree comprises one or more nodes for said request and said previously unlinked corporate entities.

4. The method of claim 3, wherein said constructing step:
(a) adds a node to an existing linkage tree as a child node of a parent node of said nodes,
(b) deletes one of said nodes by removal, or
(c) moves one of said nodes from one parent node to another parent node of said plurality of nodes.

5. The method of claim 4, wherein exemplary outputs of said constructing step comprise time stamp, an entity identity, action and/or a parent identity.

6. A system for monitoring corporate entities for a requester comprising:
a computer that has access to a memory with a program module for controlling predictive monitoring of related entities, wherein said computer controls said program module to execute the following steps:
obtaining a request for previously unlinked, corporate entities of potential interest for monitoring for said requester;
based on said request, obtaining one or more previously unlinked, corporate entities from a seed list of previously unlinked corporate entities;
constructing a linkage tree that includes said request and said obtained one or more related, but previously unlinked, corporate entities;
based on a linkage change log, finding linkage changes of said linkage tree that comprise one or more of said previously unlinked corporate entities for monitoring, which are of interest to said requester for monitoring; and
assembling a related list that includes said request and said one or more of said potential related, but previously unlinked, corporate entities of said found linkage changes.

7. The system of claim 6, wherein said request includes an identity of a currently monitored corporate entity.

8. The system of claim 7, wherein said linkage tree comprises one or more nodes for said request and said previously unlinked corporate entities.

9. The system of claim 8, wherein said constructing step:
(a) adds a node to an existing linkage tree as a child node of a parent node of said nodes,
(b) deletes one of said nodes by removal, or
(c) moves one of said nodes from one parent node to another parent node of said plurality of nodes.

10. The system of claim 9, wherein exemplary outputs of said constructing step comprise time stamp, an entity identity, action and/or a parent identity.

11. A computer readable storage media containing executable computer program instructions which when executed cause a processing system to perform a method for monitoring corporate entities for a requester comprising:
obtaining a request for previously unlinked, corporate entities of potential interest for monitoring for said requester;
based on said request, obtaining one or more previously unlinked, corporate entities from a seed list of previously unlinked corporate entities;
constructing a linkage tree that includes said request and said obtained one or more related, but previously unlinked, corporate entities;
based on a linkage change log, identifying linkage changes of said linkage tree that comprise one or more of said previously unlinked corporate entities for monitoring, which are of interest to said requester for monitoring; and
assembling a related list that includes said request and said one or more of said potential related, but previously unlinked, corporate entities of said found linkage changes.

12. The computer readable storage media of claim 11, wherein said request includes an identity of a currently monitored corporate entity.

13. The computer readable storage media of claim 12, wherein said linkage tree comprises one or more nodes for said request and said previously unlinked corporate entities.

14. The computer readable storage media of claim 13, wherein said constructing step:
(a) adds a node to an existing linkage tree as a child node of a parent node of said nodes,
(b) deletes one of said nodes by removal, or
(c) moves one of said nodes from one parent node to another parent node of said plurality of nodes.

15. The computer readable storage media of claim 14, wherein exemplary outputs of said constructing step comprise time stamp, an entity identity, action and/or a parent identity.
